(19) United States
(12) Patent Application Publication
(10) Pub. No.: US 2016/0159678 A1
(43) Pub. Date: Jun. 9, 2016

(54) APPARATUS AND METHOD FOR TEMPERING GLASS USING ELECTROMAGNETIC RADIATION

(71) Applicant: Gyrotron Technology Inc., Bensalem, PA (US)

(72) Inventors: Vladislav Sklyarevich, Bensalem, PA (US); Mykhaylo Shevelev, Bensalem, PA (US)

(73) Assignee: Gyrotron Technology, Inc., Bensalem, PA (US)

(21) Appl. No.: 14/951,696

(22) Filed: Nov. 25, 2015

Related U.S. Application Data
(63) Continuation-in-part of application No. 14/561,958, filed on Dec. 5, 2014.

(51) Int. Cl. C03B 27/012; C03B 27/052

(52) U.S. Cl. CPC C03B 27/012; C03B 27/0528

(57) ABSTRACT

A method of thermally tempering a glass sheet. The method includes preheating the glass sheet to a temperature higher than a strain point of the glass sheet and lower than a softening point of the glass sheet, exposing the glass sheet to an electromagnetic radiation in order to heat the mid-plane of the glass sheet to a temperature significantly higher than the transition point while simultaneously keeping a surface of the glass sheet at a temperature that is below the softening point, and quenching the glass sheet so that the temperature of the mid-plane and the surface of the glass sheet fall below the strain point, respectively.

This application is a continuation-in-part of application Ser. No. 14/561,958, filed on Dec. 5, 2014 for METHOD FOR GLASS TEMPERING USING MICROWAVE RADIATION.

### BACKGROUND

1. Field

The present invention pertains to methods for the thermal tempering of any type of glass or glass-like materials, preferably of a sheet of glass. h6h8

2. Description of Related Art

Glass sheets may be thermally tempered to increase the strength or breaking resistance of the glass. Traditionally, thermal tempering is performed by heating glass sheets to near the softening point of the glass, which is typically in the range of 1160° F. to 1300° F. 627° C. to 704° C.) and then rapidly cooling the surface of the glass. As a result of the rapid cooling of the surface of the glass, the mid-plane of the glass cools at a slower rate due to low glass thermal conductivity. This differential cooling results in a compressive stress in the surface regions of the glass. This compressive stress is balanced by a tension stress in the mid-plane of the glass.

The above-described process, however, suffers from several disadvantages. First, fully tempered glass that has been made in a horizontal furnace may contain surface distortions. Specifically, while the glass surface is heated to (or near) the softening point, the glass is moved by hard conveyer rollers that create marks on the surface of the glass. Second, the high temperatures cause the glass to become less flat, i.e., the glass becomes bowed.

Another disadvantage is that the temper level of the glass is limited because, as described above, the temper level depends upon the differential cooling between the surfaces and the mid-plane of the glass. Furthermore, increasing the glass temperature leads to even larger marks and even greater bowing. On the other hand, increasing the cooling rate is limited because higher air pressure is more likely to cause the hot glass to break.

Moreover, almost every thermal tempering process relies on heating the glass with infrared energy. In a case where the glass sheet has a low emissivity (low-e) coating, this infrared energy is not only reflected but also absorbed by the low-e coating causing the coating temperature to undesirably increase. In addition, those skilled in the art understand that low-e coatings are very sensitive to overheating. As a result, it is quite difficult to thermally temper a glass sheet that has a low-e coating without damaging the glass, the low-e coating, or both.

One possible approach is to address these issues is to improve the tempering equipment, in particular the quench nozzles. These approaches only minimally improve the cooling ability of the quenches. Nevertheless, the other problems mentioned above, such as those associated with roller marks and low-e coating are not solved by improving the tempering equipment.

Another possible approach is to minimize the roller marks is to simply reduce the conveyer speed. However, this approach is less than desirable because the industry prefers highly productive processes and equipment. Also, even though reducing the conveyer speed reduces the roller marks, it does not eliminate the roller marks, the glass still bows, and the low-e issues still remain.

Yet another possible approach for achieving a higher tempered stress is to utilize a multistage tempering process that includes using radio frequency (RF) radiation. However, this type of approach does not significantly increase the tempering strength and also requires equipment that is more complicated and larger. As a result, not only is more floor space required, but also the energy consumption and cost of the equipment increases. Also, even though using a multistage tempering process slightly increases the tempering strength, this approach does not solve the problems associated with the roller marks, the bowing, or the low-e coated glass.

The present inventors are not aware of any conventional method that simultaneously increases the tempering stress, eliminates roller marks and overall bow, as well as, allows effectively tempering glass with low-e coating. Thus, there is a clear need in the art for a method that substantially improves the qualities of tempered glass.

The approaches described in this section are approaches that could be pursued, but are not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not be assumed to have been recognized in any prior art on the basis of this section, unless otherwise indicated.

### SUMMARY

One or more exemplary embodiments of the present invention are intended to overcome the above disadvantages and other disadvantages not described above.

According to the present disclosure, a method is provided for thermally tempering glass sheet, comprising-preheating the glass sheet in a preheating section to a surface temperature significantly higher than a transition point of the glass sheet and lower than a softening point of the glass sheet. After that the glass sheet is moved from the preheating section into a quench section through a transferring section where it is exposed to a penetrating electromagnetic radiation with sufficient wavelength and power density in order to create the predetermined temperature distributions across the sheet while it is moved into the quench section. In the quenching section the glass sheet is cooled down so that the temperature of the mid-plane and the surface of the glass sheet fall below the strain point, respectively. The radiation is directed to both or one of the glass surfaces. In the case of tempering low-e coated glass, it is exposed to the radiation from the non-coated surface. This temperature distribution ensures the midplane temperature is not less than the surface temperature of the glass sheet after it completely moved into the quench section.

The wavelengths of the radiation are selected to provide radiation penetration depth correspondent to glass sheet thicknesses. For most industrial glass thicknesses this requirement can be meet if the radiation wavelength will be between 1 micron and about 4 microns. The power density of the radiation may be selected to be greater than a predetermined threshold and adequate enough to cause the heating of the mid-plane to be fast enough to create a sufficient temperature distribution across the glass sheet to allow tempering of the glass sheet after quenching. Thus the exemplary methods described herein use a specialized infrared sources, to emit a radiation that is in the above-mentioned range of wavelength and power densities.

Uncoated and coated glass articles tempered in accordance with the present disclosure have high temper stress and high optical quality. It is flat and does not have roller marks, as well as damage to the coating. In addition, manufacturing costs are reduced and the production rate is increased.

This glass may be used in the production of architectural window glass and doors, tables, refrigerator trays, glazing for vehicles, various types of plates, solar panels, and the like.

### BRIEF DESCRIPTION OF THE DRAWINGS

The above and/or other aspects will be more apparent by describing certain exemplary embodiments with reference to the accompanying drawings, in which:

FIG. 1 is a flowchart of a method according to the present disclosure;

FIG. 2 is a temperature distribution graph for the inside of a glass sheet during an exemplary thermal tempering, according to the present disclosure;

FIG. 3 schematically illustrates the electromagnetic radiation of a low-e coated glass sheet; and

FIG. 4 schematically illustrates an example of the radiation set up for the method of the present invention.

### DETAILED DESCRIPTION

Certain exemplary embodiments of the present inventive concept will now be described in greater detail with reference to the accompanying drawings. Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

The following detailed description is provided to assist the reader in gaining a comprehensive understanding of the methods, apparatuses, and/or systems described herein. However, various changes, modifications, and equivalents of the methods, apparatuses and/or systems described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

As provided in greater detail below, the present inventors have discovered a method for thermally tempering a glass sheet while the glass surfaces remain hard enough to prevent roller marks from occurring. That is, the mid-plane of the glass sheet is exclusively heated to the at least surface temperature or higher. This improves the qualities of the tempered glass compared to existing tempering processes where the surface is heated to a higher temperature than a midplane. In a case where the glass sheet has a low-e coating, the low-e coating reflects the radiation with a wavelength of 1-4 microns. In other words, the low-e coating does not absorb this radiation. As a result, when compared to the related art, it much easier to control the thermal tempering of a low-e coated glass sheet thereby leading to a higher quality product and a greater yield. The exemplary methods for thermally tempering a glass sheet described herein are different from previous attempts to thermally temper glass using electromagnetic radiation in that the exemplary methods described herein permit a glass article to be thermally tempered without rollers marks, bow, and to a higher stress level.

As detailed below, one or more exemplary methods of the present disclosure applies radiation with i) a wavelength that is commensurable to the thickness of the glass , and ii) a sufficient power density. The power density of the radiation should be sufficiently high to heat the mid-plane and the surfaces of the glass at least to the same temperature, overcoming thermo conductive heat flux created by the temperature difference, as well as, natural/induced heat loss. The combination of the radiation wavelength and power density, as well as heat losses from the surfaces allows the temperature of the surfaces of the glass to be less than the softening point. As a result, the mid-plane of the glass is heated fast enough to create a sufficient temperature distribution across the glass sheet thereby allowing tempering of the glass sheet after quenching. Since the surfaces of the glass are colder and, therefore, stronger when compared to the related art, the features of the present disclosure prevent roller marks from occurring and also prevent overall glass bending. In addition, because the glass is stronger relative to the related art glass, the quench air pressure can be increased in order to achieve a higher tempering level. The lower glass surface temperature also results in increases of the optical quality of the glass and requires less energy for preheating and quenching.

According to the present disclosure, the wavelength of the electromagnetic radiation and the power density of the applied electromagnetic radiation are parameters that are determined for each type of glass to be processed and its thickness. These parameters and how they are chosen are described below for an exemplary embodiment of the present disclosure in which a glass article is initially preheated to a temperature that is higher than a transition point of the glass and lower than a softening point of the glass.

As used herein the term “glass” means any type of glass or glass-like material the density of which changes suddenly with temperature. The exemplary methods described herein are generally applicable to the treatment of any type of glass. These treatments include but are not limited to glass sheets, such as those employed in the production of architectural window glass and doors, tables, refrigerator trays, glazing for vehicles, various types of plates, display glass for mobile devices and tablets, and the like.

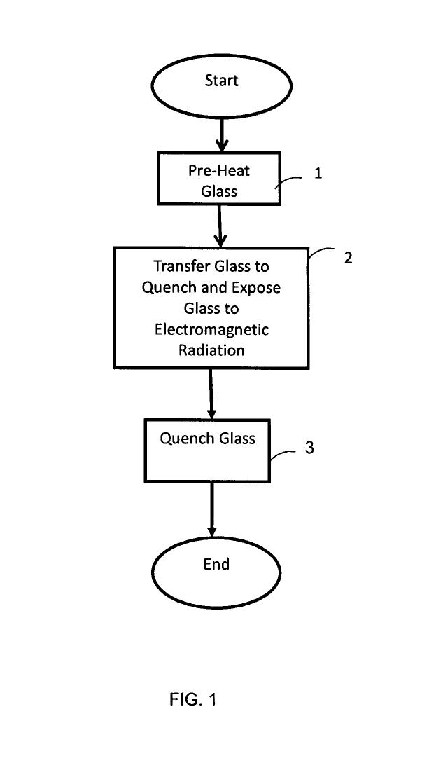

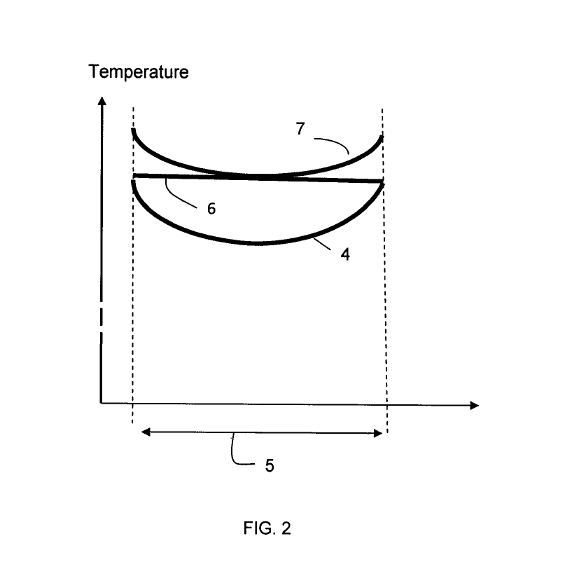

Referring to FIGS. 1 and 2, which respectively show a flowchart and a the temperature distributions across the glass article, initially at 1, the glass sheet is an preheated in an oven to a temperature higher than the transition point but lower than the softening point. After that the glass is transferred to the quench 3 through a transferring section 2 where it is exposed to the electromagnetic radiation in such a manner that the initial preheating temperature distribution 4 across the glass article thickness 5 changes to 6 while the temperature of the surface remains close to the initial preheating temperature compared to the related art where said temperature 7 is much higher. This selective heating is achieved by selecting the wavelength of the radiation correspondent to the glass penetration depth (thickness). For example, for a thick glass sheet the wavelength should be selected around 1-2 microns for common glass compositions. For thin glass, the wavelength should be in a longer range of the band. Said differently, as the thickness of the glass increases, the wavelength of the electromagnetic radiation should be decreased. The power density of the radiation is selected to overcome temperature equalizing across the thickness of the glass due to thermal conductivity. It is clear that this heating process should be short. For common glass thickness this time is in the order of a few seconds. Of course, those skilled in the art having read this specification will understand that as the thickness of the glass changes so does the duration of the radiation heating process.

The temperature difference between the glass surface and its midplane provides a tempering stress during the quenching, and this depends on the preheating temperatures, glass thickness and powers of the radiation and quenching. For example, the related art to achieve full tempering of 4mm glass (said temperature difference about 110° C.) the whole glass sheet needs to be preheated to about 650° C. which makes the glass soft and results in marks from rollers. The comparatively low surface temperature of the inventive method provides higher stiffness of the glass sheet which allows avoidance of such marks and the quench air pressure to be increased thereby resulting in a higher tempering level than that of the related art.

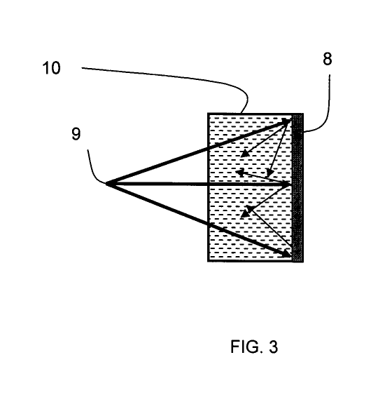

In the exemplary embodiments of the present disclosure discussed above the electromagnetic radiation may be applied from both sides simultaneously or from any one side. In a case where the glass being tempered is low-e coated, the radiation is applied from the uncoated side. Referring to FIG. 3, the low-e coating 8 can be used as a reflector to reflect radiation 9 inside of the glass 10 for increasing primary heating of the mid-plane and efficient use of electromagnetic radiation.

[Exemplary Electromagnetic Radiation Set-Up]

The foregoing exemplary embodiments and advantages are merely exemplary and are not to be construed as limiting the present inventive concept. The description of the exemplary embodiments is intended to be illustrative, and not to limit the scope of the claims, and many alternatives, modifications, and variations will be apparent to those skilled in the art.

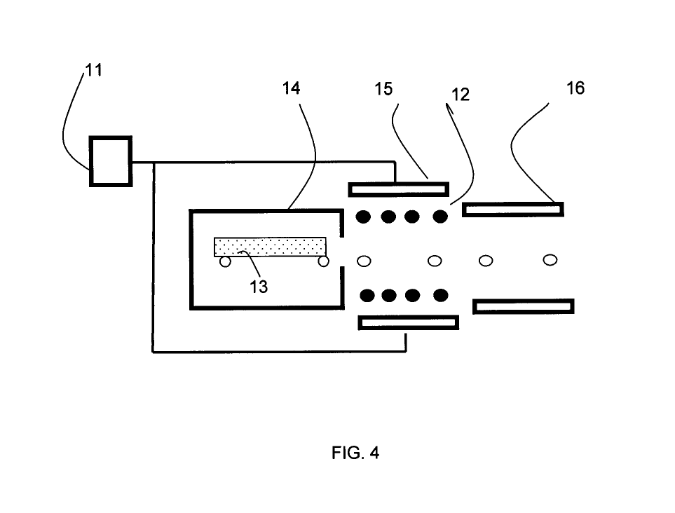

FIG. 4 shows an apparatus for thermally tempering glass. The apparatus includes a controller 11 for setting a wavelength and power of infrared quartz tubes 12 of the electromagnetic generator by changing voltage, according to a thickness of the glass 13, a preheating section (e.g., radiant heat oven 14) where glass is preheated, a transferring section 15 that exposes the glass 13 to the radiation in order to heat a non-surface portion the glass sheet to the temperature not less than the surface temperature of the glass 13 after it completely moved into quench section 16. Glass 13 is moved rapidly through the transferring section 15 with a controllable environment.

A 60 mm by 50 mm, 6 mm thick soda-lime glass plate 13 is chosen for tempering. The strain point and the softening point of soda-lime glass are about 510° C. with a transition point around 564° C., respectively. A conventional radiant heat oven 14 is chosen for preheating. However, it is understood that other forms of preheating are available.

The glass plate 13 is preheated in the oven 14 from room temperature to 580° C. The temperature of the glass plate surface is measured by pyrometer (not shown). After that the plate 13 is moved to the quench area 16 through transferring section 15 in 10 seconds. During said transfer the plate is heated by the quartz infrared tubes while it is moving. The wavelength is established to be around 1.5 microns by controller 11. The total infrared power for processing is set to 400 W, which provides a power density of around 12 watts per square centimeter. The ambient temperature in the transferring section is established to be around 100 C. The plate is rapidly cooled down by pressurized air from gas cylinders (not shown) in quench section 16.

The tempering level of the processed glass plate is evaluated and estimated to have a surface compression (or bending strength) of over 100 Mega Pascals (MPa). In comparison to the related art, the glass is fully tempered despite the preheating to a lower temperature. According to the present disclosure this insures a greater quality and is more flat.

Unless specifically stated or obvious from context, as used herein, relative terms such as “about,” “substantially,” etc., are understood as within a range of normal tolerance in the art, for example within 2 standard deviations of the mean. These relative terms can be understood as within 10%, 9%, 8%, 7%, 6%, 5%, 4%, 3%, 2%, 1%, 0.5%, 0.1%, 0.05%, or 0.01% of the stated value.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described components in the described system, architecture, or device are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of thermally tempering a glass sheet , the method comprising:
preheating the glass sheet in a preheating section to a surface temperature significantly higher than a transition point of the glass sheet and lower than a softening point of the glass sheet;
moving said sheet from the preheating section into a quench section through a transferring section wherein the glass sheet is exposed to a penetrating electromagnetic radiation having sufficient wavelength and power density to create a predetermined temperature distribution across the sheet while it moves toward the quench section; and quenching the glass sheet whereby the temperature of a mid-plane and a surface of the glass sheet fall below the strain point of the glass to obtain temper stress.

2. The method of claim 1, further comprising applying the electromagnetic radiation to at least one surface of the glass sheet.

3. The method of claim 1 wherein the radiation wavelength is selected to be between about 1 micron to about 4 microns.

4. The method of claim 1 wherein said temperature distribution ensures the midplane temperature to be not less than the surface temperature of the glass sheet after it completely moved into quench section.

5. The method of claim 1, wherein the glass sheet has a low-e coating on one surface, the method further comprising applying the electromagnetic radiation from the other surface of the glass sheet.

6. The method of claim 1, wherein the glass sheet has a coated surface that reflects electromagnetic energy and an uncoated surface, the method further comprising directing the radiation into the uncoated surface.

7. The method of claim 1, wherein the glass sheet is made from any type of glass or glass-like material the density of which changes suddenly with temperature.

8. An apparatus for thermally tempering glass, the apparatus comprising:
a preheating section for heating a glass surface of a glass sheet to a temperature higher than a transition point of the glass sheet and lower than a softening point of the glass sheet;
a transferring section including an electronmagnetice radiation generator for exposing the glass to a penetrating electromagnetic radiation in order to create a predetermined temperature distribution along and across the sheet and for transferring the glass from the heating section to quenching;
a controller for setting wavelength and power of the radiation generator according to the thickness of the glass; and
a quenching section for quenching the glass.
